(19) United States
(12) Patent Application Publication
(10) Pub. No.: US 2021/0201062 A1
(43) Pub. Date: Jul. 1, 2021

(54) METHOD AND SYSTEM FOR IMPROVING MULTI-THREADED FACE RECOGNITION ACCURACY

(71) Applicant: ANHUI ZHICHUAN TECHNOLOGY CO., LTD., Anhui (CN)

(72) Inventors: Peijin LIU, Anhui (CN); Kun ZHANG, Anhui (CN); Yongqiang YIN, Anhui (CN); Ruichao QI, Anhui (CN); Bingrong NIE, Anhui (CN); Youzhi MA, Anhui (CN)

(73) Assignee: ANHUI ZHICHUAN TECHNOLOGY CO., LTD., Anhui (CN)

(21) Appl. No.: 16/309,464

(22) PCT Filed: Oct. 31, 2018
(86) PCT No.: PCT/CN2018/112982

§ 371 Date: Dec. 13, 2018

(30) Foreign Application Priority Data
Oct. 29, 2018 (CN) 201811270415.5

(51) Int. Cl. G06K 9/00; G06K 9/62; G06F 9/50

(52) U.S. Cl. CPC G06K 9/00986; G06K 9/00288; G06F 2209/5018; G06K 9/6202; G06F 9/5027; G06K 9/00268

(57) ABSTRACT

The present application discloses a method and a system for improving multi-threaded face recognition accuracy. The method includes: acquiring an initial image; performing a face extraction on the initial image in the first CPU to obtain a face image; performing a feature extraction on the face image in the second CPU, and transmitting the facial features extracted by the feature extraction to the first CPU for a face feature comparison; outputting the face feature comparison result, after the second CPU extracts the face features in the face image, and the first CPU performs the face feature comparison according to the face features.

The present application claims priority to Chinese Patent Application No. 201811270415.5, filed to the Chinese Patent Office on Oct. 29, 2018, entitled “Method and system for improving multi-threaded face recognition accuracy”, the entire disclosure of which is incorporated herein by reference.

### TECHNICAL FIELD

The present application relates to the field of face recognition technology, and in particular, to a method and a system for improving multi-threaded face recognition accuracy.

### BACKGROUND OF THE INVENTION

At present, with the maturity of cameras, algorithms, data volume and other conditions, face recognition technology has gradually become a kind of underlying application tool technology, which has been popularized. It is no longer rare to use face recognition technology to realize attendance management and security verification.

Face recognition is a biometric recognition technology based on human facial feature information for identification. Face recognition generally includes steps such as image acquisition, face extraction, feature extraction and feature comparison. Wherein, face extraction and feature comparison take less time, and feature extraction takes longer. Face recognition processing by single thread often reduces the face recognition efficiency due to waiting for feature extraction.

### SUMMARY OF THE INVENTION

Based on the technical problems existing in the background art, the present application proposes a method and a system for improving multi-threaded face recognition accuracy.

The present application proposes a method for improving multi-threaded face recognition accuracy, which includes:

acquiring an initial image;

performing a face extraction on the initial image in the first CPU to obtain a face image;

performing a feature extraction on the face image in the second CPU, and transmitting the facial features extracted by the feature extraction to the first CPU for a face feature comparison;

outputting the face feature comparison result, after the second CPU extracts the face features in the face image, and the first CPU performs the face feature comparison according to the face features.

Preferably, at least one face information is included in the initial image.

The present application also proposes a system for improving multi-threaded face recognition accuracy, which includes:

an image acquisition module, configured to acquire an initial image, and send the initial image to the first processing module;

a first processing module, configured to receive the initial image sent by the image acquiring module, perform face extraction on the initial image, and send the face image obtained by the face extraction to the second processing module; and configured to receive the face feature sent by the second processing module, comparing the face features according to the facial features and preset face features, and output the feature comparison results;

a second processing module, configured to receive a facial image sent by the first processing module, perform feature extraction on the facial image, and send the facial feature extracted by the feature to the first processing module.

Preferably, the image acquisition module is specifically configured that: at least one face information is included in the acquired initial image.

Preferably, the first processing module includes at least one CPU.

Preferably, the second processing module includes at least one CPU.

In the present application, after acquiring the initial image, the face extraction on the initial image is performed in the first CPU to obtain a face image, the feature extraction on the face image is performed in the second CPU, and the facial features extracted by the feature extraction is transmitted to the first CPU for the face feature comparison; the face feature comparison result is outputted after the second CPU extracts the face features in the face image, and the first CPU performs the face feature comparison according to the face features. In this way, using two parallel CPUs can perform the face extraction and the face feature comparison at the same time as the feature extraction, which greatly improves the efficiency of the face recognition.

### BRIEF DESCRIPTION OF DRAWING

FIG. 1 is a schematic flow chart of a method for improving multi-threaded face recognition accuracy according to the present application;

FIG. 2 is a schematic block diagram of a system for improving multi-threaded face recognition accuracy according to the present application.

### DETAILED DESCRIPTION OF THE INVENTION

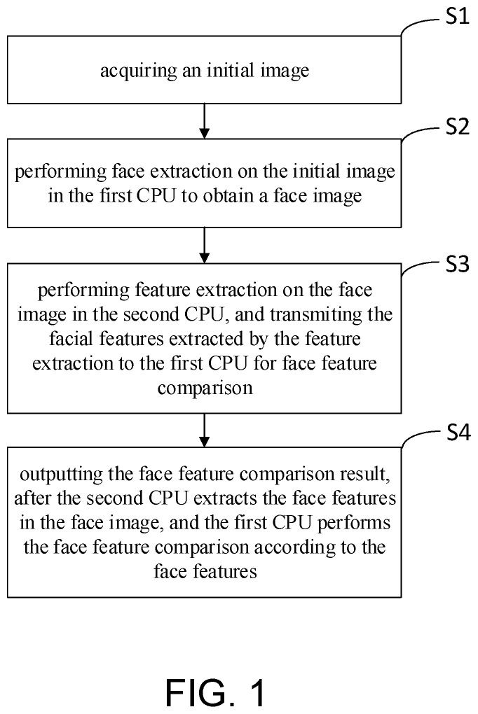

Referring to FIG. 1, the present application provides a method for improving multi-threaded face recognition accuracy, which includes:

Acquiring an initial image, wherein, at least one face information is included in the initial image.

In a specific embodiment, the initial image, that is, the initial character image, is acquired by a preset image capturing device. Further, in order to ensure the accuracy of the subsequent face extraction and the feature extraction, the initial image is subjected to image preprocessing such as gradation correction and noise filtering.

A face extraction is performed on the initial image in the first CPU to obtain a face image.

A feature extraction is performed on the face image in the second CPU, and the facial features extracted by the feature extraction is transmitted to the first CPU for the face feature comparison.

The face feature comparison result is outputted, after the second CPU extracts the face features in the face image, and the first CPU performs the face feature comparison according to the face features.

In a specific embodiment, the time for the face extraction of the initial image by a single thread is T1, the time for the feature extraction of the face image is T2, the time for performing the face feature comparison according to the extracted face feature is T3, and the face recognition time is T1+T2+T3; The feature extraction is performed in the second CPU by performing the face extraction and the face feature comparison in the first CPU, and the face recognition time can be the larger one of T1+T3 and T2. Due to T1+T3 and T2 are both smaller than T1+T2+T3, which greatly improves the efficiency of face recognition.

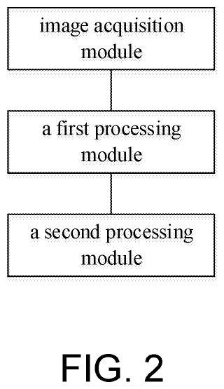

Referring to FIG. 2, the present application provides a system for improving multi-threaded face recognition accuracy, which includes:

an image acquisition module, configured to acquire an initial image, and send the initial image to the first processing module, the image acquisition module is specifically configured that: at least one face information is included in the acquired initial image.

In a specific embodiment, the initial image, that is, the initial character image, is acquired by a preset image capturing device. Further, in order to ensure the accuracy of the subsequent face extraction and feature extraction, the initial image is subjected to image preprocessing such as gradation correction and noise filtering.

A first processing module is configured to receive the initial image sent by the image acquiring module, perform the face extraction on the initial image, and send the face image obtained by the face extraction to the second processing module; and configured to receive the face feature sent by the second processing module, comparing the face features according to the facial features and preset face features, and output the feature comparison results, the first processing module includes at least one CPU.

A second processing module is configured to receive a facial image sent by the first processing module, perform feature extraction on the facial image, and send the facial feature extracted by the feature to the first processing module. The second processing module includes at least one CPU.

In a specific embodiment, the time for face extraction of the initial image by a single thread is T1, the time for the feature extraction of the face image is T2, the time for performing the face feature comparison according to the extracted face feature is T3, and the face recognition time is T1+T2+T3. The feature extraction is performed in the second CPU by performing the face extraction and the face feature comparison in the first CPU, and the face recognition time can be the larger one of T1+T3 and T2. Due to T1+T3 and T2 are both smaller than T1+T2+T3, which greatly improves the efficiency of face recognition.

In the present embodiment, after acquiring the initial image, the face extraction is performed on the initial image in the first CPU to obtain a face image, the feature extraction is performed on the face image in the second CPU, and the facial features extracted by the feature extraction is transmitted to the first CPU for face feature comparison; the face feature comparison result is outputted, after the second CPU extracts the face features in the face image, and the first CPU performs the face feature comparison according to the face features. In this way, using two parallel CPUs can perform the face extraction and the face feature comparison at the same time as the feature extraction, which greatly improves the efficiency of face recognition.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

What is claimed is:

1. A method for improving multi-threaded face recognition accuracy, characterized by, comprising:
acquiring an initial image;
performing a face extraction on the initial image in the first CPU to obtain a face image;
performing a feature extraction on the face image in the second CPU, and transmitting the facial features extracted by the feature extraction to the first CPU for a face feature comparison;
outputting a result of the face feature comparison, after the second CPU extracts the face features in the face image, and the first CPU performs the face feature comparison according to the face features.

2. The method for improving multi-threaded face recognition accuracy according to claim 1, characterized in that, at least one face information is included in the initial image.

3. A system for improving multi-threaded face recognition accuracy, characterized by, comprising:
an image acquisition module, configured to acquire an initial image, and send the initial image to the first processing module;
a first processing module, configured to receive the initial image sent by the image acquiring module, perform a face extraction on the initial image, and send the face image obtained by the face extraction to the second processing module; and configured to receive the face feature sent by the second processing module, comparing the face features according to the facial features and preset face features, and output a result of the feature comparison;
a second processing module, configured to receive a facial image sent by the first processing module, perform a feature extraction on the facial image, and send the facial feature extracted by the feature to the first processing module.

4. The system for improving multi-threaded face recognition accuracy according to claim 3, characterized in that, the image acquisition module is specifically configured that: at least one face information is included in the acquired initial image.

5. The system for improving multi-threaded face recognition accuracy according to claim 3, characterized in that, the first processing module includes at least one CPU.

6. The system for improving multi-threaded face recognition accuracy according to claim 3, characterized in that, the second processing module includes at least one CPU.
